(19) United States
(12) Patent Application Publication
(10) Pub. No.: US 2004/0060743 A1
(43) Pub. Date: Apr. 1, 2004

(54) Automatic cards switching device and switching method therefor, and carry belt, card control mechanism and power transmission mechanism

(76) Inventor: Masaharu Hara, Higashimatuyama-shi (JP)

Correspondence Address: Rocco S Barrese, Dilworth & Barrese, 333 Earle Ovington Boulevard, Uniondale, NY, 11553, US

(21) Appl. No.: 10/416,408

(22) PCT Filed: Sep. 11, 2002
(86) PCT No.: PCT/JP02/09251

(30) Foreign Application Priority Data
Sep. 12, 2001 (JP) 2001-276217
Sep. 10, 2002 (JP) 2002-263523

(51) Int. Cl. G01G 13/00

(52) U.S. Cl. 177/52

(57) ABSTRACT

In the case of playing cards such as playing cards and the like, the switching of cards have been conventionally performed using automatic switching apparatuses in a place such as a casino where there are many participants. Many of such conventional apparatuses, however, need a technical skill in operation of the apparatuses themselves, or have a complicated structure themselves. In such conventional apparatuses, moreover, there has been no switching apparatus which is enjoyable to game participants when they see the apparatus.

An apparatus of the present invention is an automatic switching apparatus comprising: a delivery box portion for locating cards thereon and for transferring the cards one by one; a plurality of card boxes for separating the transferred cards; a controller portion for controlling the delivery box portion main body and its inner parts via a motor; and a deck portion for receiving the card from the card box and for returning the card to the delivery box, wherein the located cards are positioned in card boxes at random by actions of an ejection mechanism and a mechanism for transferring the cards one by one to the card boxes, and then, are returned in another path to the card place.

### TECHNICAL FIELD

The present invention relates to an apparatus that can automatically and at random switch cards, in particular, to a novel apparatus for automatically switching cards and a novel method for automatically shuffling cards, wherein, cards located on a delivery box can be transferred one by one by a feed mechanism comprising a carry belt and the like, and be located at random on a plurality of card boxes from a lower side thereof via an ejection mechanism, and inversely, the cards in a shuffled state can be transferred one by one with a carry roller by driving of a fix roller and a send-back rubber from an upper portion of the located cards, and be returned to the original delivery box.

### BACKGROUND ART

When several persons play cards, the dealer typically shuffles by hand and at random the cards to play. In a place where a number of persons play cards such as in a casino and the like, however, it has been known that the switching of cards is performed with an automatic apparatus in stead of shuffling by hand so that nobody can cheat at cards.

As an example of such apparatuses, Japanese Patent First Publication No. 10-507103 “an apparatus and a method for automatically shuffling cards” discloses an apparatus for shuffling cards comprising: (a) a first magazine being vertically extendable for supporting a stack of vertically aligned cards which are not shuffled; (b) a second magazine and a third magazine each being vertically extendable for supporting a stack of cards aligned in a vertical direction, the second magazine and the third magazine each being spaced apart from the first magazine in a horizontal direction and being connected to the first magazine; (c) a first card engaging means being disposed at a top portion of the first magazine for driving cards one by one from a top portion of the stack of cards within the first magazine to the second and the third magazines in a horizontal direction and shuffling the stack of cards which are not shuffled, into two stacks; and (d) a second and a third card engaging means each being disposed at each top portion of the second and the third magazine, so as to provide an electromechanical machine for shuffling many packs of cards in order to make it easy to play cards in a casino.

In the above-mentioned conventional apparatus, however, there must be great uncertainty about the possibility of completely shuffling cards. In addition, it has been desired to develop a novel apparatus with which anyone can shuffle cards at random by simple means.

### DISCLOSURE OF THE INVENTION

As a result of the thorough consideration for solving such problems stated above, an apparatus has been developed comprising a mechanism for locating cards which are located on a delivery box, on card boxes at random from a lower portion thereof in a state in which an order of the plurality of cards are switched via a feed mechanism and an ejection mechanism of a delivery box portion, and at an arbitrary time, for returning the cards from an upper portion of the card boxes in another path to the delivery box.

That is, a first of the present invention is an apparatus for automatically switching cards such as playing cards, comprising:

a delivery box portion for locating cards thereon and for transferring the cards one by one;

a plurality of card boxes for separating the transferred cards;

a controller for controlling the delivery box portion itself and its inner parts via a motor; and

a deck portion for receiving the card from the card box and for returning the card to the delivery box,

wherein the delivery box portion comprises:

a card place for locating the cards thereon;

a carry belt for transferring the located cards one by one;

a feed mechanism for transferring the card on the belt while supporting the card on the belt; and

an ejection mechanism for ejecting the transferred cards from the delivery box portion to the card boxes,

wherein the card boxes comprise a plurality of divider portions having a base roller for positioning the cards thereon transferred by the belt of the delivery box portion, and

wherein the deck portion comprises as a main portion a fix roller and a send-back rubber for making contact with a top portion of the cards positioned on the card boxes.

A second of the present invention is an apparatus for automatically switching cards according to claim 1, wherein, when transferring the cards on a card place bottom portion by the carry belt one by one, while supporting the card on the belt, the feed mechanism transfers the cards while a bottom portion of the cards is supported at prescribed portions by base guides provided on right and left sides, and then, an upper card surface is supported by a vertical guide provided above a guide pin on a direction of transfer, and also the upper surface is supported by at least one or more shafts provided above the carry belt.

A third of the present invention is an apparatus for automatically switching cards according to claim 1, wherein, while locating on an ejection belt the cards transferred by the belt provided within the delivery box portion, the ejection mechanism for ejecting the cards from the delivery box portion to the card boxes, supports the upper surface of the cards at the upper surface by a send-guide, supports the cards by a bound plate positioned in front of the send-guide, and ejects the cards to the card boxes by an ejection roller.

A fourth of the present invention is an apparatus for automatically switching cards according to claim 1, wherein the deck portion is adapted such that the cards are drawn out one by one by the fix roller and the send-back rubber for making contact with the top portion of the cards positioned on the card boxes, and are transferred by rotary actions of the fix roller and a carry roller so that the cards pass between a send-back shaft and a send-back guide.

A fifth of the present invention is a method for automatically switching cards such as playing cards, comprising locating by controller control at random on card boxes from a lower position thereof cards which are located on a delivery box, while locating in order on the delivery box to a lower position thereof the cards from an upper position thereof located on the card boxes.

A sixth of the present invention is a method for automatically switching cards such as playing cards, comprising the steps of:

providing a delivery box means for locating cards thereon and for transferring the cards one by one;

providing a plurality of card box means for separating the transferred cards;

providing a controller for controlling the delivery box portion itself and its inner parts via a motor; and

providing a deck means for receiving the cards from the card boxes and for returning the cards to the delivery box,

wherein the delivery box means transfers cards having been located on a card place one by one from the card place for locating the cards thereon while locating the card on a carry belt and supporting both sides and an upper surface of the card by guides and a shaft,

wherein the card box means receive by at least one or more base rollers the cards transferred by the carry belt of the delivery box means, and locate the cards at random on card boxes comprising a plurality of divider portions by stacking the cards from bottom portions of the card boxes, and

wherein, when some or all of the cards are located on the card boxes, the located cards are drawn out one by one by an action of a fix roller and a send-back rubber of the deck means so that the cards are passed between a send-back shaft and a send-back guide provided within the delivery box portion so as to be located on an original card place bottom portion.

A seventh of the present invention is a carry belt for transferring cards, comprising evenly spaced protrusions provided on an inner belt surface and protrusions provided on a part of an outer belt surface which transfer a card while pushing up the card.

An eighth of the present invention is a card control mechanism used in an apparatus for automatically switching cards, which holds an upper card surface when feeding the card and is positioned at a lower card surface when ejecting the card, comprising a bound plate which is connected with a connection shaft 14 provided on an ejection belt 44 for transferring the cards, and a connection roller integrated with the bound plate.

A ninth of the present invention is a power transfer mechanism used in an apparatus for automatically switching cards, wherein a flexible roller whose contact surface is rotated back and forth by a motion of a belt, and a send roller disposed oppositely to the flexible roller are connected by a roller guide positioned at support shafts of both the rollers, and wherein, in a case that rotation of an ejection belt for a card is in a counterclockwise direction, only the flexible roller rotates, and inversely, in a case that rotation of the ejection belt is in a clockwise direction, the flexible roller makes contact with the send roller disposed oppositely to the flexible roller while the flexible roller is also rotated clockwise so as to allow the send roller to be rotated counterclockwise.

### BRIEF DESCRIPTION OF THE DRAWINGS

FIG. 1 is a perspective view generally showing an apparatus of the present invention;

FIG. 2 is a sectional view showing a delivery box portion of an apparatus of the present invention;

FIG. 3 is a perspective view of an apparatus of the present invention generally as seen from a front direction thereof;

FIG. 4 is a general view showing a delivery box portion of an apparatus of the present invention;

FIG. 5 is an arrangement view showing an interior of a delivery box portion of an apparatus of the present invention;

FIG. 6 is a sectional view of a deck portion of an apparatus of the present invention;

FIG. 7 is a sectional view of a carry belt used in an apparatus of the present invention;

FIG. 8 is a partially-enlarged view of protrusions on an upper surface of a carry belt used in an apparatus of the present invention;

FIG. 9 is a surface view of a power transfer mechanism used in an apparatus of the present invention; and

FIG. 10 is a partial sectional view of FIG. 9.

### EXPLANATION OF REFERENCE NUMBERS

1 . . . a delivery box portion,

2 . . . a card case,

3 . . . a card box,

4 . . . a motor A (a delivery motor),

5 . . . a motor B,

6 . . . a base roller,

7 . . . a carry belt,

8 . . . a base guide L,

9 . . . a base guide R,

10 . . . a guide pin,

11 . . . a vertical guide,

12 . . . a shaft 1,

13 . . . a shaft 2,

14 . . . a connection shaft,

15 . . . a send-guide,

16 . . . a send-guide,

17 . . . a positioning pin,

18 . . . a base roller A,

19 . . . a base roller B,

20 . . . a send-back roller,

21 . . . a send-back guide,

22 . . . a side panel L,

23 . . . a side panel R,

24 . . . a fix roller A,

25 . . . a controller,

26 . . . a carrier belt upper surface protrusion,

27 . . . a carrier belt lower surface protrusion,

28 . . . an apparatus upper base,

29 . . . an apparatus lower base,

30 . . . a deck portion,

31 . . . a fix roller B,

32 . . . a carry roller,

33 . . . a carry shaft,

34 . . . a send-back rubber,

35 . . . a playing card,

36 . . . a bound plate,

37 . . . a connection roller,

38 . . . a pulley A,

39 . . . a pulley B,

40 . . . a pulley C,

41 . . . a pulley D,

42 . . . an ejection roller,

43 . . . an ejection open/close plate,

44 . . . an ejection belt,

45 . . . a tension suppression roller,

46 . . . a delivery belt,

47 . . . a belt,

48 . . . a motor C (a deck motor),

49 . . . a delivery motor pulley,

50 . . . a card place,

51 . . . a flexible roller,

52 . . . a send roller,

53 . . . a roller guide,

54 . . . a transfer portion outer frame,

55 . . . a flexible roller support shaft, and

56 . . . a power transfer mechanism support plate.

### BEST MODES FOR CARRYING OUT THE INVENTION

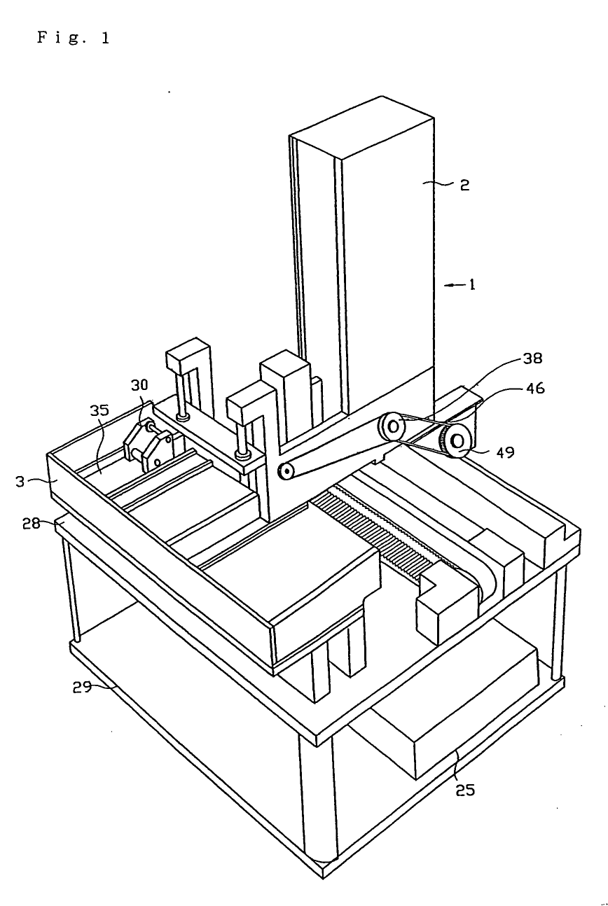

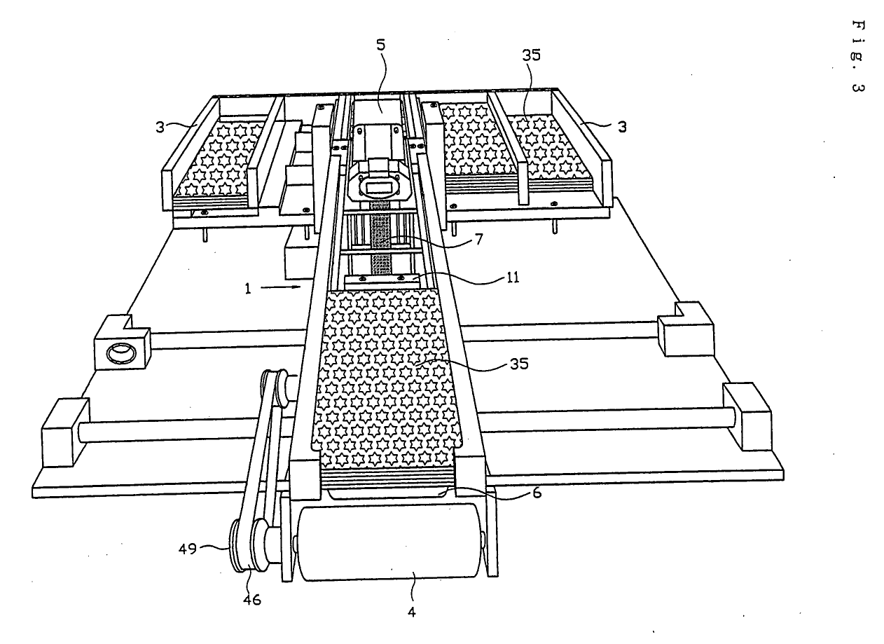

FIG. 1 and FIG. 3 are perspective views showing an outline of an apparatus of the present invention. As a basic construction, a constitution of the apparatus of the present invention comprises: a delivery box portion 1 for locating cards, for example, playing cards 35 thereon and for transferring the cards one by one; a plurality of card boxes 3 for separating the transferred cards; a motor 4 for transferring the delivery box portion 1 along right and left guides 9 and 8; a motor 5 for move up or down a deck portion; and the deck portion 30 for receiving the card from the card box 3 and for returning the card to the delivery box 1.

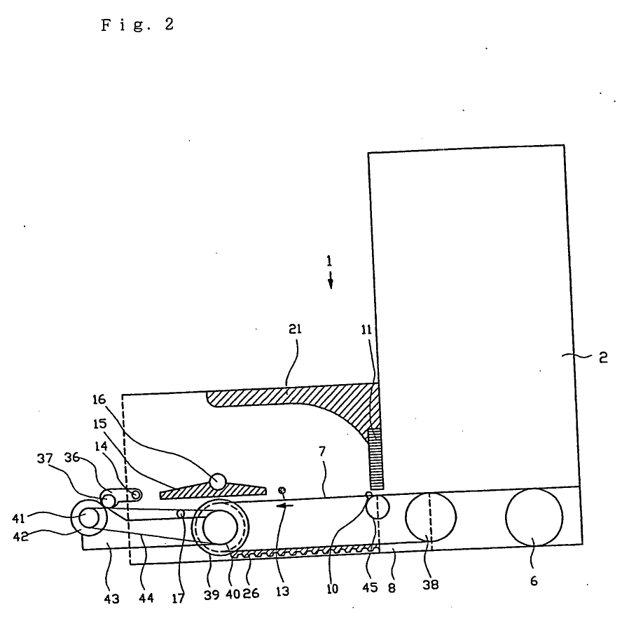

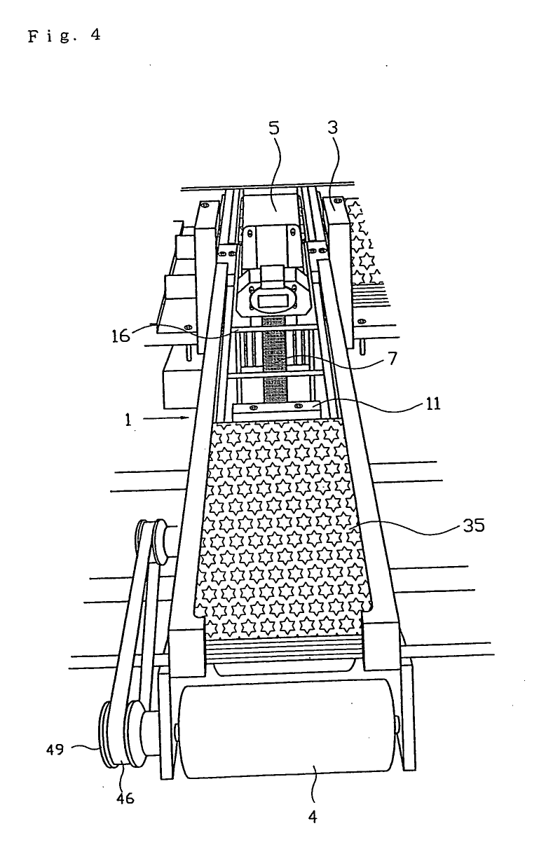

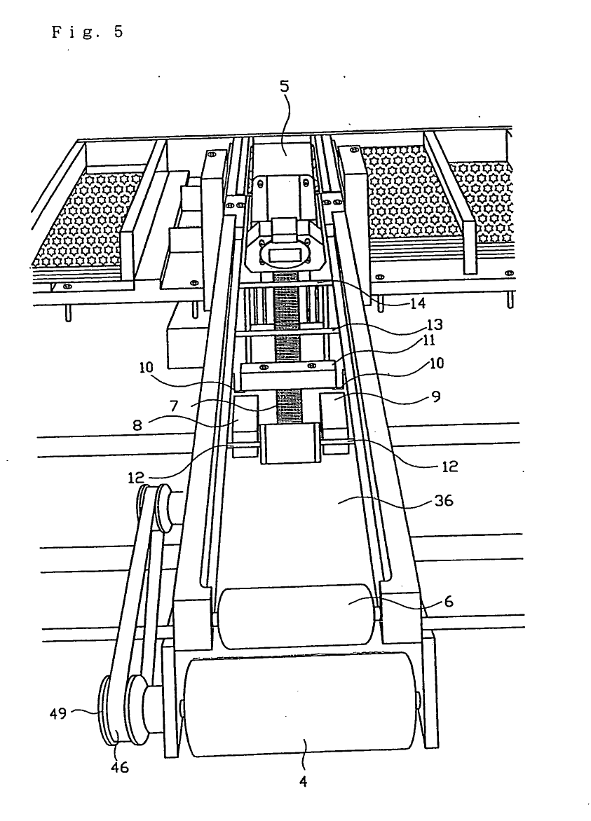

In these components, the delivery box portion 1, as shown in FIG. 4 and FIG. 5, comprises: the delivery box portion 1 comprises: a card place 50 for fitting with a card case 2 and for locating the playing cards 35 thereon; a carry belt 7 for transferring the located cards one by one; a feed mechanism, including the base guides 8 and 9 and shafts 12, 13 and 14, for transferring the card on the belt while supporting the card on the belt; and an ejection mechanism for ejecting the transferred playing cards 35 from the delivery box portion to the card boxes. These components, when transferring the cards 35 on a card place 50 bottom portion by the carry belt 7 of the feed mechanism one by one, as shown in FIG. 2, transfer the cards 35 in a state in which a bottom portion of the cards 35 is supported at prescribed portions by protruded portions provided on the base guides 9 and 8 provided on right and left sides, and then, in a state in which an upper card 35 surface is supported by a vertical guide 11 provided above a guide pin 10 on a direction of transfer.

The transferred card 35 is located on an ejection belt 44 of the ejection mechanism to be transferred to an ejection roller 42 side. There is a structure (hereinafter referred to as a card control mechanism) for pressing against the upper surface of the card a connection roller 37 integrated with a bound plate 36 which is connected with the connection shaft 14 provided on the ejection shaft. In this case, the connection roller 37 is controlled to move up or down to a predetermined height at several degrees with the shaft 14 being as a center of a circular motion, and the card 35 is transferred to the card box 3 in a state in which the card 35 is pressed by the pressing force of the bound plate 36 which is integrated with the connection roller 37.

Since the transferred playing cards 35 are sent to the card boxes 3 in the state in which the card 35 is pressed by the action of the bound plate 36, the cards 35 are stacked from the lower portion toward the upper portion in the card boxes 3. When the cards 35 are ejected to the card boxes 3 as in such a case, an ejection open/close plate 43 for supporting the ejection roller 42 comes into contact with a positioning pin 17 by the action of a circular motion of a pulley C 40 to stop so that the ejection roller 42 becomes in a state in which the ejection roller makes contact with the card which is located at the bottom surface of the card boxes.

The structure of this card boxes 3 comprises a plurality of divider portions having base rollers 18 and 19 for positioning the cards 35 thereon transferred by the ejection mechanism. The base rollers 18 and 19 are constructed to receive the playing cards 35 transferred by the carry belt 7 provided within the delivery box portion 1 and to locate the cards into a stack from the bottom portion in the card boxes 3 by at least one or more base rollers 18 and 19.

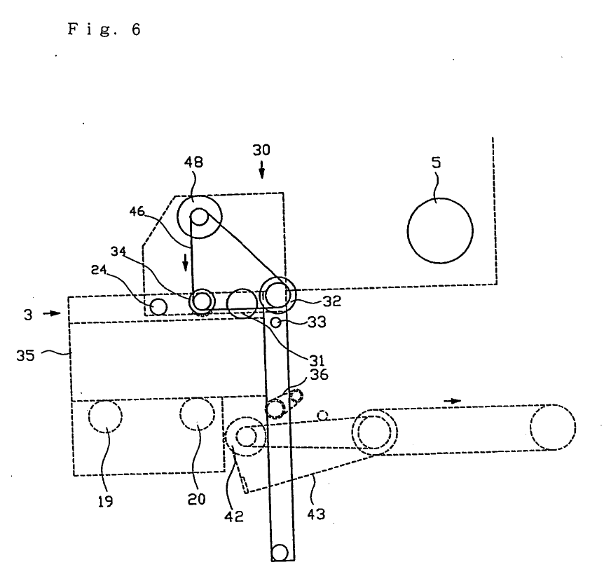

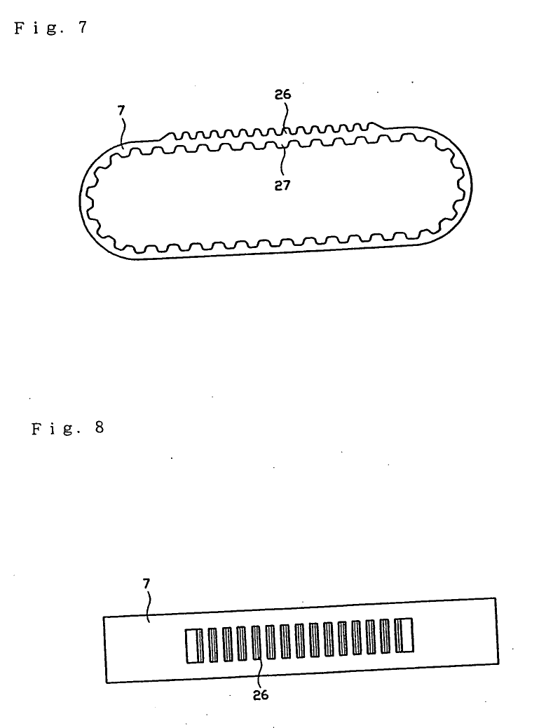

The deck portion 30 positioned at a top portion of the playing cards 35 located on the card boxes 3 as shown in FIG. 6 is adapted such that the cards 35 are drawn out one by one by a send-back rubber 34 for making contact with the top portion of the cards 35 positioned on the card boxes as shown in the drawing, and then, are transferred by rotary actions of fix rollers 24 and 31 and a carry roller 32 so as to allow the cards 35 to pass between a send-back shaft 16 and a send-back guide 21 provided within the delivery box portion 1 as shown in FIG. 2, so that the cards 35 are located on an original card place 36 in a state in which the cards 35 are switched.

In this case, contrary to the case where the cards 35 are ejected to the card boxes 3, the ejection open/close plate 43 is in a state in which the ejection roller 42 side is lowered, and at the same time, a tip of the bound plate 36 integrated with the connection roller 37 is also lowered. Moreover, the cards 35 which are drawn out by the send-back rubber 34 are passed through the upper portion of the bound plate 36, and are passed between the send guide 16 and the send-back guide 21, and then, are passed between the vertical guide 11, and the guide pin 10 and the base guide 8, so as to be located on the bottom portion of the card place.

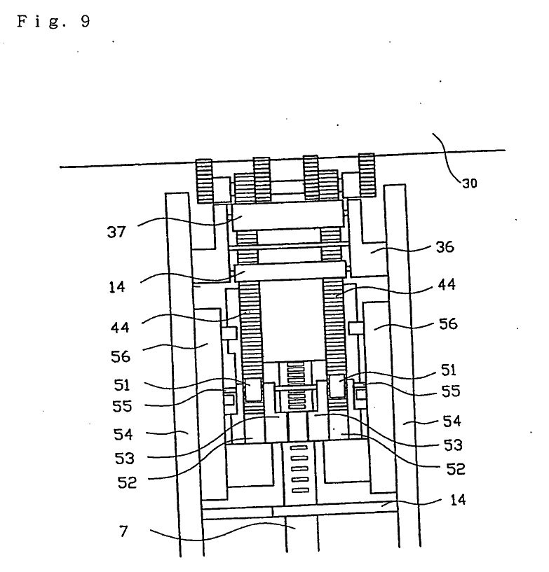

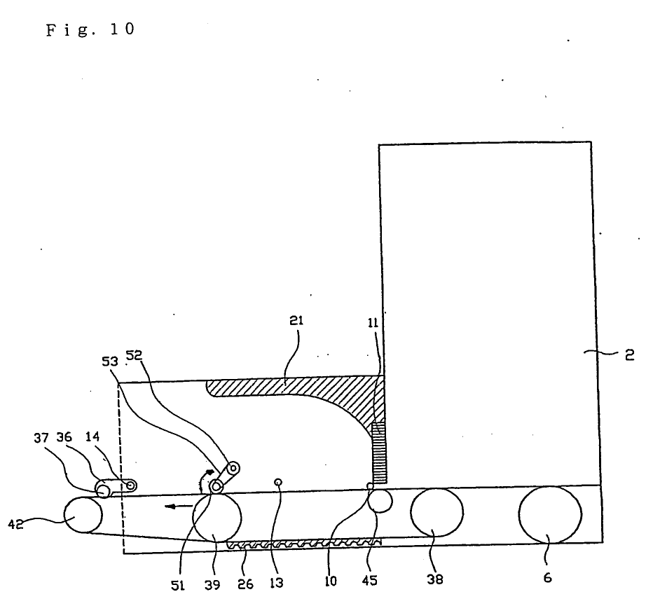

The operation of the above-described card control mechanism is performed by a belt system wherein a pulley D 41 and the pulley C 40 provided outside the delivery box portion 1 are rotated via the ejection belt 44 therebetween, as shown in FIG. 2 and FIG. 6. In stead of the belt system, however, the operation of the above-described card control mechanism may be performed by a power transfer mechanism wherein a flexible roller whose contact surface is rotated back and forth on a carry belt by a motion of the carry belt, and a send roller disposed oppositely to the flexible roller are connected by a roller guide positioned at support shafts of both the rollers, as shown FIG. 9 and FIG. 10.

In such a case, when the ejection belt allows cards to proceed in a counterclockwise direction, the flexible roller rotates in a clockwise direction. In this case, however, the flexible roller does not make contact with the send roller disposed oppositely to it. Inversely, when the rotation of the ejection belt is in a clockwise direction, the flexible roller shifts slightly to the side of the send roller disposed oppositely to the flexible roller to make contact with the send roller while the flexible roller is rotated counterclockwise so as to allow the send roller to be rotated clockwise. This makes the operation possible in a smarter and more energy-efficient manner than the mechanism wherein the pulley D 41 and the pulley C 40 provided outside the delivery box portion 1 are rotated via the ejection belt 44 therebetween, as described above.

As the carry belt 7 of the feed mechanism of the present invention, a belt is used that comprises evenly spaced protrusions 27 provided on an inner belt surface and protrusions 26 provided on a part of an outer belt surface which transfer a card while pushing up the card. Since the card is transferred while pushed up by these protrusions 26 on the outer surface, the cards can be transferred one by one.

As a procedure for operating the apparatus of the present invention, a method for automatically switching cards, comprising the steps of: providing a delivery box means for locating cards 35 thereon and for transferring the cards 35 one by one; providing a plurality of card box means for separating the transferred cards; providing a controller means for controlling the delivery box portion along right and left guides; and providing a deck means for receiving the cards from the card boxes and for returning the cards to the delivery box, wherein the delivery box means transfers cards 35 having been located on a card place 50 one by one from the card place 50 for locating the cards thereon while locating the card on a carry belt 7 and supporting both sides and an upper surface of the card by guides and a shaft, wherein the card box means locate the cards 35 transferred by the carry belt 7 of the delivery box means, on at least one or more at random by stacking the cards from bottom portions, and wherein, when the cards 35 from the card place 50 are located on the card boxes 3, a fix roller 24 and a send-back rubber 34 of the deck means draw out the located cards 35 one by one so that the cards are passed between a send-back shaft 16 and a send-back guide 21 provided within the delivery box portion 1 so as to be located on an original card place 50 in a state in which the cards 35 are switched.

### INDUSTRIAL APPLICABILITY

Since an operator has only to locate on the card place 50 playing cards 35 which are contained in a card case so that the operator can switch the playing cards while controlling the switching at random automatically with a controller 25, the apparatus of the present invention has an advantage wherein anyone can operate the apparatus freely even if the person does not have the expertise to operate equipment.

Since cards are located from a plurality of lower divider portions of the card boxes while the cards are transferred one by one using the carry belt 7 whose upper surface is provided with protrusions, and the located cards are shuffled while the located cards are returned at random from the upper of the cards to the original card place 50, the switching (shuffling) can be performed a nearly infinite number of times so that cheating at cards in switching can be prevented.

1. An apparatus for automatically switching cards such as playing cards, comprising:
a delivery box portion for locating cards thereon and for transferring the cards one by one;
a plurality of card boxes for separating the transferred cards;
a controller for controlling the delivery box portion itself and its inner parts via a motor; and
a deck portion for receiving the card from the card box and for returning the card to the delivery box,
wherein the delivery box portion comprises:
a card place for locating the cards thereon;
a carry belt for transferring the located cards one by one;
a feed mechanism for transferring the card on the belt while supporting the card on the belt; and
an ejection mechanism for ejecting the transferred cards from the delivery box portion to the card boxes,
wherein the card boxes comprise a plurality of divider portions having a base roller for positioning the cards thereon transferred by the belt of the delivery box portion, and
wherein the deck portion comprises as a main portion a fix roller and a send-back rubber for making contact with a top portion of the cards positioned on the card boxes.

2. An apparatus for automatically switching cards according to claim 1, wherein, when transferring the cards on a card place bottom portion by the carry belt one by one, while supporting the card on the belt, the feed mechanism transfers the cards while a bottom portion of the cards is supported at prescribed portions by base guides provided on right and left sides, and then, an upper card surface is supported by a vertical guide provided above a guide pin on a direction of transfer, and also the upper surface is supported by at least one or more shafts provided above the carry belt.

3. An apparatus for automatically switching cards according to claim 1, wherein, while locating on an ejection belt the cards transferred by the belt provided within the delivery box portion, the ejection mechanism for ejecting the cards from the delivery box portion to the card boxes, supports the upper surface of the cards at the upper surface by a send-guide, supports the cards by a bound plate positioned in front of the send-guide, and ejects the cards to the card boxes by an ejection roller.

4. An apparatus for automatically switching cards according to claim 1, wherein the deck portion is adapted such that the cards are drawn out one by one by the fix roller and the send-back rubber for making contact with the top portion of the cards positioned on the card boxes, and are transferred by rotary actions of the fix roller and a carry roller so that the cards pass between a send-back shaft and a send-back guide.

5. A method for automatically switching cards such as playing cards, comprising locating by controller control at random on card boxes from a lower position thereof cards which are located on a delivery box, while locating in order on the delivery box to a lower position thereof the cards from an upper position thereof located on the card boxes.

6. A method for automatically switching cards such as playing cards, comprising the steps of:
providing a delivery box means for locating cards thereon and for transferring the cards one by one;
providing a plurality of card box means for separating the transferred cards;
providing a controller means for controlling the delivery box portion itself and its inner parts via a motor; and
providing a deck means for receiving the cards from the card boxes and for returning the cards to the delivery box,
wherein the delivery box means transfers cards having been located on a card place one by one from the card place for locating the cards thereon while locating the card on a carry belt and supporting both sides and an upper surface of the card by guides and a shaft,
wherein the card box means receive by at least one or more base rollers the cards transferred by the carry belt of the delivery box means, and locate the cards at random on card boxes comprising a plurality of divider portions by stacking the cards from bottom portions of the card boxes, and
wherein, when some or all of the cards are located on the card boxes, the located cards are drawn out one by one by an action of a fix roller and a send-back rubber of the deck means so that the cards are passed between a send-back shaft and a send-back guide provided within the delivery box portion so as to be located on an original card place bottom portion.

7. A carry belt for transferring cards, comprising evenly spaced protrusions provided on an inner belt surface and protrusions provided on a part of an outer belt surface which transfer a card while pushing up the card.

8. A card control mechanism used in an apparatus for automatically switching cards, which holds an upper card surface when feeding the card and is positioned at a lower card surface when ejecting the card, comprising a bound plate which is connected with a connection shaft 14 provided on an ejection belt 44 for transferring the cards, and a connection roller integrated with the bound plate.

9. A power transfer mechanism used in an apparatus for automatically switching cards, wherein a flexible roller whose contact surface is rotated back and forth by a motion of a belt, and a send roller disposed oppositely to the flexible roller are connected by a roller guide positioned at support shafts of both the rollers, and wherein, in a case that rotation of an ejection belt for a card is in a counterclockwise direction, only the flexible roller rotates, and inversely, in a case that rotation of the ejection belt is in a clockwise direction, the flexible roller makes contact with the send roller disposed oppositely to the flexible roller while the flexible roller is also rotated clockwise so as to allow the send roller to be rotated counterclockwise.
